(19) United States
(12) Patent Application Publication
(10) Pub. No.: US 2010/0162029 A1
(43) Pub. Date: Jun. 24, 2010

(54) SYSTEMS AND METHODS FOR PROCESS IMPROVEMENT IN PRODUCTION ENVIRONMENTS

(75) Inventors: Haydn J. Powell, Minooka, IL (US); Luiz Carlos Calil, Piracicaba (BR)

Correspondence Address: Caterpillar Inc.;Intellectual Property Dept., AH 9510, 100 N.E. Adams Street, PEORIA, IL, 61629-9510, US

(73) Assignee: Caterpillar Inc., Peoria, IL (US)

(21) Appl. No.: 12/623,677

(22) Filed: Nov. 23, 2009

Related U.S. Application Data
(60) Provisional application No. 61/193,736, filed on Dec. 19, 2008.

(51) Int. Cl. G06F 11/07; G06F 3/048

(52) U.S. Cl. 714/2; 714/37; 714/46; 714/E11.023; 714/E11.029

(57) ABSTRACT

A computer-implemented method is provided for identifying a root cause associated with a problem in a production environment. The method includes receiving information indicative of a point-of-origin of the problem. The method further includes providing a cause-and-effect chart having a plurality of user-definable general cause categories, each of the general cause categories having at least one user-definable direct cause subcategory. The method further automatically identifies a primary direct cause of the problem based on the user-defined general cause categories and direct cause subcategories. The method further includes automatically generating a root cause analysis report associated with the primary direct cause, where generating the report includes displaying the cause-and-effect chart and prompting the user for a response to a first of a plurality of questions, wherein the response to the first of the plurality of questions automatically prompts the user for a response to a second of a plurality of questions.

### RELATED APPLICATIONS

This application is based upon and claims the benefit of priority from U.S. Provisional Application No. 61/193,736 by Haydn J. Powell et al., filed Dec. 19, 2008, the contents of which are expressly incorporated herein by reference.

### TECHNICAL FIELD

This disclosure relates generally to process improvement tools and, more particularly, to systems and methods for displaying a root cause analysis and a corrective action plan associated with a problem in a production environment.

### BACKGROUND

In the manufacturing industry, businesses have utilized several methodologies to develop process improvement and corrective action plans, including “Six Sigma,” Pareto Analysis, and Ishikawa Charting. However, when using these methods, most corrective decisions are made with only local or low-level knowledge. The root causes of problems and their associated corrective actions are neither standardized nor sufficiently detailed.

Previously, developed process improvement methods have produced fragmented results, forcing users to apply, separately, various process improvement methodologies to determine the cause of a problem and corrective action required. One such method for implementing process improvement is described in U.S. Pat. No. 6,463,441 to Paradies (the '441 patent). The '441 patent utilizes a computer implemented system which progresses through multiple analysis levels to identify a human factor that represents a root cause of a particular failure incident. Specifically, the system described in the '441 patent provides a graphical user interface that allows a user to select a specific type of failure incident from a predetermined list of incidents. Based on the incident selected by the user, the system may provide a predetermined list of causal factors attributed with causing the failure incident, for selection by the user. Upon selection of the causal factor by the user, the system presents a list of potential root causes associated with a human operator that led to the causal factor for selection by the user. Each root cause is associated with one or more predefined corrective actions. Upon selection of a specific root cause by the user, the system of the '441 patent generates a report summarizing the corrective actions associated with the selected root cause.

Although the system of the '441 patent may aid in identifying a root cause associated with a particular incident and provide a report to the user suggesting potential corrective measures to mitigate the causes that led to the incident in certain situations, it may have several disadvantages. The system of the '441 patent may not provide users with an interface or report that automatically formats information relating to the root cause analysis and corrective action plan onto a single user display. The system of the '441 patent provides multiple reporting options, each including multiple page reports and lengthy summaries. The system of the '441 patent fails to provide a user with a report including conventional cause-and-effect (Ishikawa) and “5-why” analysis diagrams. Accordingly, users that rely on such analysis diagrams may be required to manually generate separate reports, which may be time-consuming and inefficient. Similarly, information corresponding to the root cause analysis and associated corrective action planning are not included on a single interface. Users assisted by a single display of problem identification and resolution analysis, as applied to the problem being evaluated, must manually combine and re-interpret the reports generated by the '441 patent.

Additionally, the '441 patent does not permit a user to prioritize between multiple problems or causal elements. The '441 patent does not allow users to consider different casual elements' relative contribution to the problem as a whole, or their contribution to various aspects of the problem. The '441 patent thereby fails to focus the problem evaluation and process improvement plans on those factors that have the largest impact on the problem. Without such capabilities it is possible that a user may focus evaluation and improvement efforts on those causes that will have the least impact on the overall problem, providing a somewhat limited root cause determination and ineffective problem resolution. The systems and methods associated with the present disclosure are directed to overcoming or mitigating one or more of the problems set forth above.

### SUMMARY

In one aspect, the present disclosure is directed to a computer-implemented method for identifying a root cause associated with a problem in a production environment. The method may include receiving, from a user interface module, information indicative of a point-of-origin of the problem. The method may also include providing, via the user interface module, a cause-and-effect chart, the cause-and-effect chart having a plurality of user-definable general cause categories, and each of the plurality of user-definable general cause categories having at least one user-definable direct cause subcategory. The method may also include receiving, from the user interface module, at least one general cause category and at least one direct cause subcategory associated with the cause-and-effect chart. The method may also include automatically identifying a primary direct cause of the problem based on the at least one general cause category and the at least one direct cause subcategory. The method may also include automatically generating a root cause analysis report associated with the identified primary direct cause. Where generating the root cause analysis report may also include providing a first analysis module that displays the cause-and-effect chart based on the at least one general cause category and the at least one direct cause subcategory, and providing a second analysis module that prompts the user for a response to a first of a plurality of questions, wherein the response to the first of the plurality of questions automatically prompts the user for a response to a second of a plurality of questions.

An additional aspect of the present disclosure is directed to a computer-readable medium for use on a computer system, the computer readable medium having computer executable instructions for performing a method of identifying a root cause associated with a problem in a production environment. The computer-readable medium may also include instructions for receiving, from a user interface module, information indicative of a point-of-origin of the problem. The computer-readable medium may also include instructions for providing, via the user interface module, a cause-and-effect chart, the cause-and-effect chart having a plurality of user-definable general cause categories, each of the plurality of user-definable general cause categories having at least one user-definable direct cause subcategory. The computer-readable medium may also include instructions for receiving, from the user interface module, at least one general cause category and at least one direct cause subcategory associated with the cause-and-effect chart. The computer-readable medium may also include instructions for automatically identifying a primary direct cause of the problem based on the at least one general cause category and the at least one direct cause subcategory, and automatically generating a root cause analysis report associated with the identified primary direct cause. The computer-readable medium may also include instructions for generating the root cause analysis report including providing a first analysis module that displays the cause-and-effect chart based on the at least one general cause category and the at least one direct cause subcategory, and providing a second analysis module that prompts the user for a response to a first of a plurality of questions, wherein the response to the first of the plurality of questions automatically prompts the user for a response to a second of a plurality of questions.

An additional aspect of the present disclosure is directed to a system for identifying a root cause associated with a problem in a production environment. The system may include a console and at least one input device coupled to a processor. The processor may be configured to receive, from a user interface module, information indicative of a point-of-origin of the problem and provide, via the user interface module, a cause-and-effect chart, the cause-and-effect chart having a plurality of user-definable general cause categories, each of the plurality of user-definable general cause categories having at least one user-definable direct cause subcategory. The processor may be further configured to receive, from the user interface module, at least one general cause category and at least one direct cause subcategory associated with the cause-and-effect chart. The processor may be further configured to automatically identify a primary direct cause of the problem based on the at least one general cause category and the at least one direct cause subcategory and automatically generate a root cause analysis report associated with the identified primary direct cause. The processor may further be configured to generate a root cause analysis report including providing a first analysis module that displays the cause-and-effect chart based on the at least one general cause category and the at least one direct cause subcategory, and providing a second analysis module that prompts the user for a response to a first of a plurality of questions, wherein the response to the first of the plurality of questions automatically prompts the user for a response to a second of a plurality of questions.

### BRIEF DESCRIPTION OF THE DRAWINGS

FIG. 1 is a block illustration of an exemplary disclosed computer system capable of implementing the methods and systems disclosed;

FIG. 2 is an illustration of modules which may be included in a root cause analysis system; and

FIG. 3 is a flowchart illustration of one method for utilizing a root cause analysis system consistent with the present disclosure.

### DETAILED DESCRIPTION

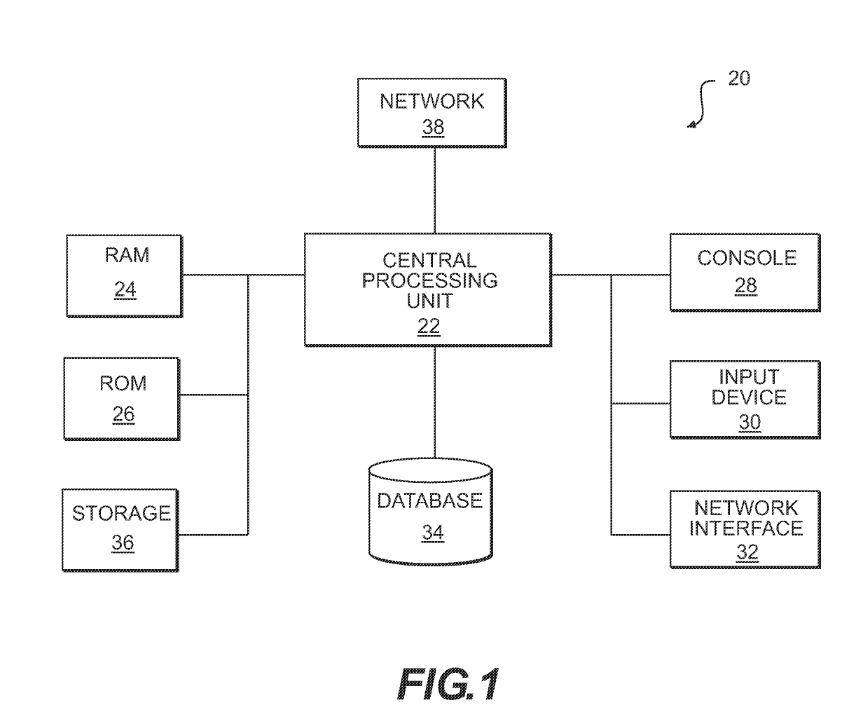

FIG. 1 illustrates an exemplary root cause analysis system 20, on which processes, methods, and instructions consistent with the disclosed embodiments may be implemented. Root cause analysis system 20 may embody any suitable microprocessor-based computer system such as, for example, a desktop or portable computer, a workstation, a server, a personal digital assistant, or any other computer system. Root cause analysis system 20 may include a central processing unit (CPU) 22, a random access memory (RAM) 24, a read-only memory (ROM) 26, a console 28, an input device 30, a network interface 32, at least one database 34, and storage 36. It is contemplated that the root cause analysis system 20 may include additional, fewer, and/or different components than those listed above. It is understood that the type and number of devices are exemplary only and not intended to be limiting.

Root cause analysis system 20 may include a group of computer programs, program modules, and computer readable data stored on a computer readable media that cooperate to cause CPU 22 to identify and analyze root causes for problems in, for example, production environments and plan corrective action(s), based on the root cause analysis. The computer program instructions may be loaded into RAM 24 for execution by CPU 22 from ROM 26. In an exemplary embodiment, the disclosed methods and systems may be implemented as a computer program running on a computer. Furthermore, the methods and systems disclosed herein may be implemented using numerous operating environments such as, but not limited to, DOS, Linus, Windows, VMS, VAX, BeOS, Solaris, OS/2, Macintosh, UNIX, and any other suitable or future developed operating system.

Root cause analysis system 20 may interface with a user via console 28, input device 30, and network interface 32. In particular, console 28 may provide a graphics user interface (GUI) to display information to users of root cause analysis system 20. Console 28 may be any appropriate type of computer display device or computer monitor. Input device 30 may be provided for users to input information into root cause analysis system 20. Input device 30 may include, for example, a keyboard, a mouse, or other optical or wireless computer input devices. Further, network interface 32 may provide communication connections that provide connectivity between root cause analysis system 20 and computer network 38.

Root cause analysis system 20 may also include storage 36 that is configured to record, catalog, and organize any data information that CPU 22 may require to perform processes consistent with the disclosed embodiments. Storage 26 may include any suitable mass storage device. For example, storage 36 may include one or more hard disk devices, optical disk devices, or other storage devices to provide storage space.

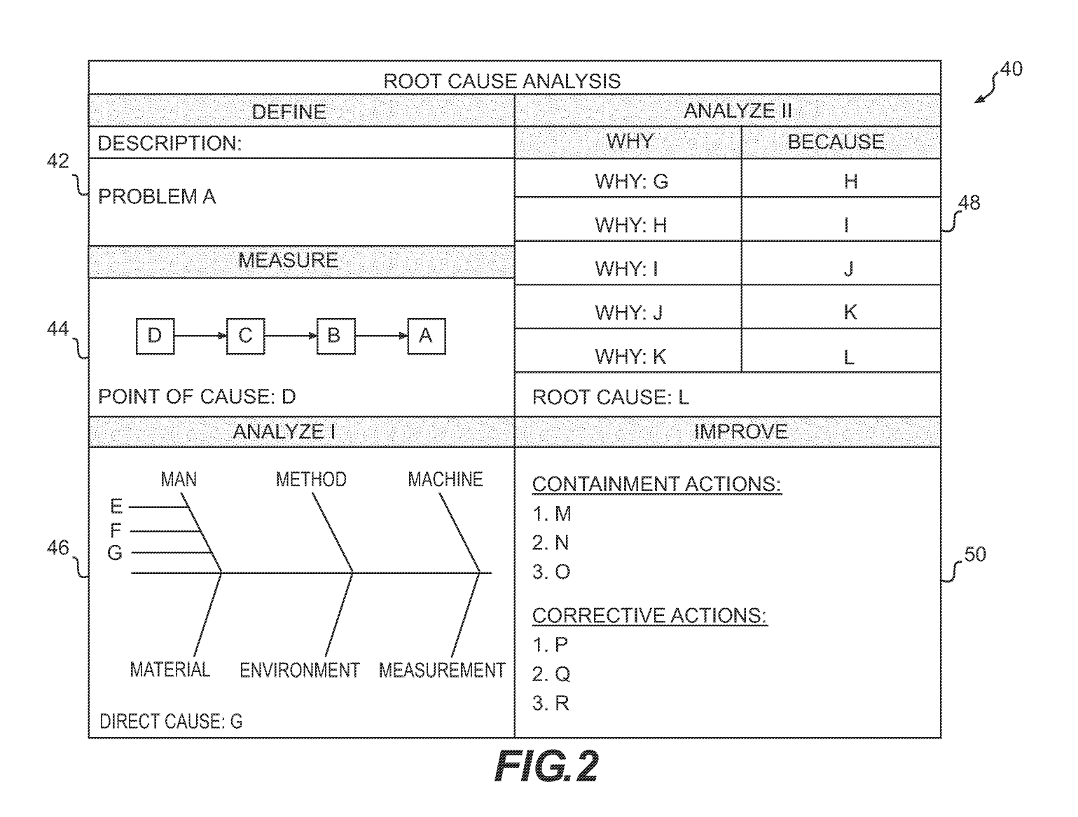

FIG. 2 illustrates an exemplary root cause analysis module 40, which may be generated by root cause analysis system 20. Root cause analysis module 40 may be configured to receive data in one or more analysis sub-modules associated with the root cause analysis module 40. Based on the received data, root cause analysis module 40 may identify a root cause of a problem associated with a product or process. A root cause, as the term is used herein, refers to a primary or fundamental reason or basis to which a particular problem with a production environment may be attributed. The root cause analysis module 40 may identify a root cause of the problem by applying one or more algorithms included in the root cause analysis system 20 to collected data. CPU 22 may then present information related to root cause, to a GUI for example, in the form of a visual display, or report, or any other suitable data display method. Root cause analysis system 40, and its associated analysis modules, may also be configured to store received data and may archive such data for later use. Data may be stored in a database 34, a computer file, paper-based forms, or in computer RAM (e.g., as object data), etc.

Root cause analysis module 40 may include a plurality of sub-modules relating to general problem definition, identification of direct and root problem causes, and development of containment actions and corrective actions necessary to neutralize and/or resolve the root problem. For example, root cause analysis module 40 may include a problem definition module 42, a problem measurement module 44, a first-level analysis module 46, a second-level analysis module 48, and a third-level analysis module 50. These sub-modules within the root cause analysis module 40 may act as input and display devices for root cause analysis system 20 performing the root cause analysis. The modules may be software-based modules (e.g., software objects) that receive data and display textual data, diagrams, charts, or other display type items.

Sub-modules included within root cause analysis module 40 may be associated with one or more interfaces and may each include background interfaces and related sub-interfaces. Such background interfaces and sub-interfaces may be software interfaces that, although not viewable or accessible by a user when operating on root cause analysis module 40, may be linked to a respective sub-module. As such, users may input data or otherwise interact with background interfaces and sub-interfaces. The data input into the background interfaces and sub-interfaces may be analyzed, formatted, and/or incorporated into sub-modules of root cause analysis module 40, for delivery and/or display to the user. The background interfaces and sub-interfaces may be used for, among other things, raw data entry, review, and report generation, etc. The associated interfaces may facilitate acquisition of data from paper-based forms, electronic data entry interfaces, electronic databases, or via other suitable data acquisition subsystems. Modules and sub-modules associated with root cause analysis module 40 may be configured to receive and retrieve data from one or more databases, modules, sub-modules, and/or interfaces, consistent with the user-defined selections and entries associated with a respective module/sub-module.

Certain selectable features within a module may be accessed by clicking, double clicking, viewing, or other suitable method. Accessing such items may cause features associated with the item to be displayed on console 28. For example, upon accessing an item within a module, a sub-module associated with that item may be displayed on console 28. By further example, accessing an item within a sub-module may cause another level (e.g., a sub-sub-module) of related modules to be presented, similar to a process sometimes referred to in the art as “drilling down.” For example, a user may interact with an interface associated first-level analysis module 46 to define parameters associated with a cause-and-effect chart provided by first-level analysis module 46.

Problem definition module 42 may receive from a user input a problem to be evaluated using the root cause analysis system 20. “Problem,” as the term is used herein, may include a user identified failure, inefficiency, or other type of deficiency associated with a process or product in an environment such as a production environment. For example, in identifying a problem to be evaluated using root cause analysis system 20, a user may utilize one or more process maps, flowcharts, Gantt charts, check sheets, and/or any other suitable performance indicator to identify process or product inefficiencies or failures. Problem definition module 42 may display, via console 28, a graphical or textual representation of the problem.

Problem measurement module 44 may include, among other things, an interface that prompts a user for information indicative of a point-of-origin of the problem to be evaluated by root cause analysis system 20. The point-of-origin, or “point of cause,” of a problem may embody the origination point of the problem, and may include an identification of the origination point of product/process failure.

Through a series of interrogations, problem measurement module 44 prompts the user to enter information tracking the resultant process or product error identified by the problem definition module 42, to the original point of cause of the identified problem. Problem measurement module 44 may automatically prompt the user through a series inquiries to enter information determinative of when and where the identified problem originated. For example, as shown in FIG. 2, problem definition module 42 may define the problem for analysis as “Problem A.” Through a series of queries, the origination point of Problem A is determined. As shown in FIG. 2, problem measurement module 44 may display, via console 28, a graphical or textual representation of the user's logical progression to the point-of-origin of the problem. Similarly, problem measurement module 44 may display a textual description of the point of cause of the problem.

For example, Problem A may be associated with a problem of material availability necessary to complete a manufacturing process in a production environment. In this example, problem measurement module 44 may be configured to identify one or more factors that may contribute to the presence of Problem A. The user may be prompted to enter a response to a query to identify contributory factors, and the user's response would provide the basis for the next user query as to a contributory factor. In this example, the user may respond with response B. Problem measurement module 44 may then query the user as to what factors contributed to response B. In response the user may input response C. The series of inquiries may continue until the user in confident that origination point of the problem has been identified. As shown in exemplary problem measurement module 44 displayed in FIG. 2, the point-of-origin of problem A is identified as D.

First-level analysis module 46 may provide an interface that allows users to identify the primary direct cause of the problem specified by the problem definition module 42 and isolated by the problem measurement module 44. First-level analysis module 46 may provide a cause-and-effect (commonly referred to as “fishbone”) chart that includes a plurality of user-defined parameters. First-level analysis module 46 may receive from a user at least one general cause category. Alternatively, first-level analysis module 46 may receive a predetermined set of general cause categories from a database. A general cause category, as the term is used herein, may represent a broad category or characterization of potential causes of the problem. For example, general cause categories may include, man, method, machine, material, mother nature (i.e., environment), and/or measurement. In this example, the “MAN” general cause category may correspond to causes of a problem that are associated with the human interaction with a product or process.

First-level analysis module 46 may receive, from a user input, at least one direct cause subcategory. A direct cause subcategory, as the term is used herein, may represent a more specific cause associated with the respective general cause category as applied to the problem being evaluated. For example, a direct cause subcategory associated with the MAN general cause may include causes associated with personnel availability or causes associated with employee skill. It is contemplated that first-level analysis module may include additional levels of cause categories until a desired level of specificity is reached.

First-level analysis module 46 may provide, via console 28, a graphical or textual representation of a cause-and-effect or “fishbone” chart. The cause-and-effect chart may represent a graphical arrangement of general cause categories and their associated direct cause subcategory in a hierarchical “fishbone” diagram. As shown in FIG. 2, this graphical representation may include a horizontal line from which extends several stems, or “bones,” each representing a respective general cause category. Extending from each of the general cause category stems, may be one or more stems representing a respective direct cause subcategory. For example, as shown in FIG. 2, the MAN general cause category may include direct causes E, F, and G.

First-level analysis module 46 may receive from a user, weighting factors associated with each of the general cause categories. The weighting factors associated with each of the general cause categories may represent the portion of the problem attributed to the respective general cause category. First-level analysis module 46 may also receive from a user weighting factors associated with each of the direct cause subcategories. The weighting factors associated with the a direct cause subcategory may represent the portion of the respective general cause category associated with the direct cause subcategory.

Based on the received weighting factors, first-level analysis module 46 may identify as the primary direct cause, the direct cause with the proportionally highest weighting factor. The user may provide a weighting factor attributing 80% of the problem being evaluated to the MAN general cause category, with the remaining 20% divided between the remaining general cause categories. Within the MAN general cause category the user identified direct causes E, F, and G. The user may provide a weighting factor attributing 50% of the MAN general cause category to direct cause G, with the remaining 50% divided between direct causes E and F. In this example, 80% of the total problem is attributed to the MAN general cause category, 50% of the MAN general cause category is attributed to direct cause G. Therefore, 40% of the total problem is attributed to direct cause G, and G is therefore identified as the primary direct cause.

First-level analysis module 46 may include a Pareto analysis sub-module (not shown). Pareto analysis sub-module may provide an interface that allows users to identify a primary direct cause when a plurality of primary direct causes are identified by first-level analysis module 46. Pareto analysis sub-module may receive, based on user interaction with first-level analysis module 46, data representative of the frequency of each of a plurality of direct causes. The Pareto analysis sub-module may provide, via console 28, a graphical or textual representation of a Pareto chart. The Pareto chart may represent a graphical arrangement wherein frequency of occurrence data associated with a direct cause is graphed on a left vertical axis, the right vertical axis representing the cumulative percentage of the total number of occurrences of the representative general cause. The horizontal axis includes data segmented into groups representative of each of the direct causes. The data is then ordered in descending order of frequency magnitude. The resultant Pareto chart identifies and prioritizes the direct causes according to a level of frequency of occurrence. Using the Pareto chart, the Pareto analysis sub-module identifies the primary direct cause as the direct cause with the highest cumulative percentage of the total number of occurrences associated with the representative general cause.

As shown in FIG. 2, first-level analysis module 46 may provide, via console 28, a graphical or textual representation of a cause-and-effect or “fishbone” chart, a graphical representation of the Pareto chart created by the Pareto analysis sub-module, or a textual description of the direct cause(s).

Second-level analysis module 48 may provide an interface that allows users to identify the root cause of the direct cause identified by first-level analysis module 46. Root cause, as the term is used herein, refers to an underlying issue (“cause”) of the primary direct cause identified by first-level analysis module 46. According to one embodiment, root cause may be classified or identified as the lowest-level event or series of events that are attributable to the primary direct cause. Second-level analysis module 48, either directly or via a sub-module, may prompt the user for a response to a first of a plurality of questions. The first of a plurality of questions is based on the primary direct cause identified my first-level analysis module 46. The response to the first of the plurality of questions, automatically prompts the user for a response to a second of a plurality of questions. It is contemplated that second-level analysis module 48 may successively prompt the user for a response to a plurality of other questions, wherein the response to the previous questions provides the basis for the subsequent question. It is contemplated that this pattern may continue until the user has reached a desired level of specificity, at which point the response to the last of the plurality of questions is identified as the root cause of the direct cause identified by first-level analysis module 46. For example, as shown in FIG. 2, direct cause G provides the basis for the first of the plurality of questions. In response to first of the plurality of questions the user might enter response H. Response H automatically prompts second-level analysis module 48 to prompt the user for a response to the second of the plurality of questions. In response to the second of the plurality of questions, the user might enter response I. This pattern may continue until the user has reached a desired level of specificity, at which point the root cause of the problem is identified. As shown in FIG. 2, the root cause associated with the primary direct cause is identified as L.

Second-level analysis module may provide, via console 28, graphical or textual representation of a plurality of questions provided the user, and the user's entered responses. Second-level analysis module 48 may also provide a textual description of the root cause.

Third-level analysis module 50 may provide an interface that allows users to identify at least one corrective action and a containment action in response to the root cause identified by second-level analysis module 48. A corrective action, as the term is used herein, may include a recommendation for resolving the problem in the production environment. A containment action, as the term is used herein, may include a recommendation for reducing the immediate impact of the problem in the production environment.

Third-level analysis module 50 may identify containment actions and corrective actions either directly or via a sub-module. For example, third-level analysis module 50 may utilize a containment action sub-module (not shown), the sub-module may query the user to identify at least one containment action to alleviate the immediate effects of the root cause. Additionally, third-level analysis module 50 may utilize, for example, a corrective action sub-module (not shown). Using the corrective action sub-module, improvement module 50 queries the user to identify corrective actions and/or countermeasures necessary to eliminate the root cause. It is contemplated that containment and/or corrective actions may also, in addition to being user-defined, be predetermined for a particular root cause. For example, based on historical experience, containment and corrective actions that provided solutions for solving previous occurrences of root causes may be stored in a database. Once a root cause has been identified by second-level analysis module 48, CPU 22 may query database 34 for a list of possible corrective and/or containment actions that had previous success at resolving the root cause. Third-level analysis module 50 may provide, via console 28, graphical or textual representation of the user identified corrective and containment actions. For example, as shown in FIG. 2, the user has identified containment actions M, N, and O, and corrective actions P, Q, and R.

Third-level analysis module 50 may provide a corrective action plan report. Third-level analysis module 50 may prompt the user to provide status data and completion date data corresponding to the identified corrective actions or countermeasures. Third-level analysis module 50 may provide an interface wherein the user may track the progress and status of a corrective or containment action. Third-level analysis module 50 may provide the corrective action plan report, via a graphical representation, computer file, paper-based forms, or any suitable format. The corrective action plan report may include, among other things, the problem defined by problem definition module 42, root cause identified by second-level analysis module 48, corrective actions or countermeasures identified for the root cause, status data, and completion date data.

Root cause analysis module 40 may provide within a single display format a representation of the problem definition module 42, a problem measurement module 44, a first-level analysis module 46, a second-level analysis module 48, and a third-level analysis module 50. The single display format may include a graphical or textual display provided via console 28, a computer file, paper-based forms, or any other means appropriate.

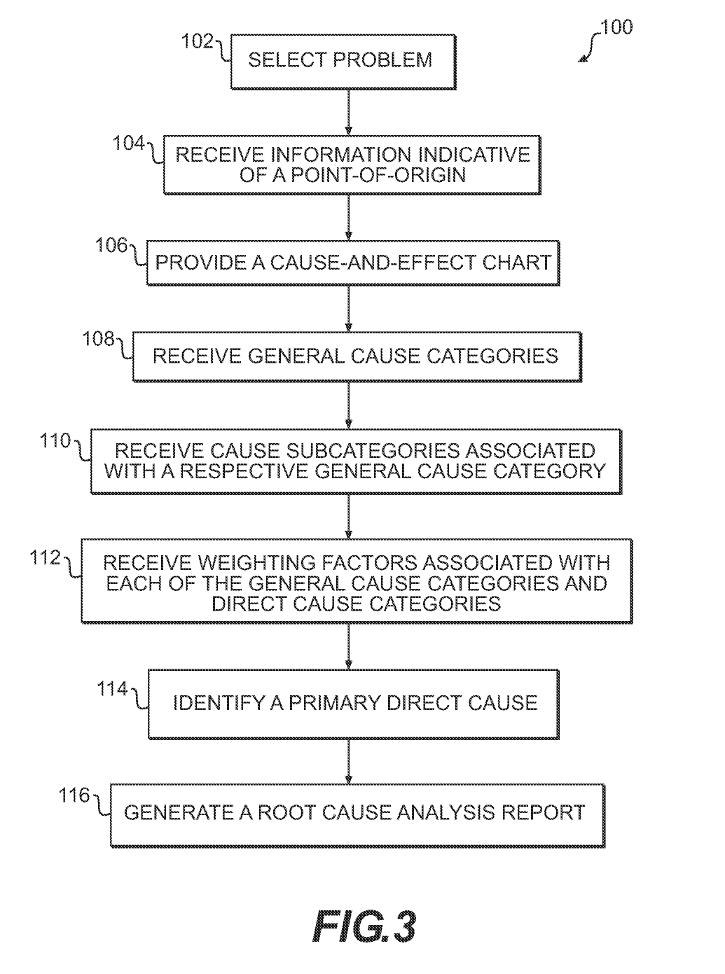

FIG. 3 is a flowchart 100 illustrating an exemplary method that utilizes root cause analysis system 20 to identify a root cause and corrective action associated with a problem in a production environment consistent with the present disclosure. It is contemplated that the method may alternatively be implemented manually without the use of root cause analysis system 20. As indicated in FIG. 3, the first step of the method may include user selection of a problem for evaluation (step 102). The user may select a problem based on various factors and using various methods, including for example, previously defined procedure check sheets and charts, histograms, key performance indicators (KPI), and Pareto analysis. For the purposes of this disclosure, a problem may include, among other things, material availability, machine failure, machine malfunction, startup losses, quality control, etc.

Once a problem has been selected for analysis, data indicative of a point-of-origin of the problem is received from a user interface module (step 104). By identifying the point-of-origin of the problem, the user narrows the scope of root cause analysis system's 20 examination of the selected problem. The user interface module may prompt the user to track the problem to its origination point through a series of queries.

Once the point-of-origin has been identified, a cause-and-effect chart is provided via the user interface module to identify the direct cause of the problem (step 106). The cause-and-effect chart may include a plurality of general cause categories, wherein each of the general cause categories may include at least one direct cause subcategories. Upon providing the cause-and-effect chart, general cause categories are received from the user interface module (step 108). General cause categories may include traditional cause-and-effect categories, such as, man, method, machine, material, mother nature (i.e., environment), and/or measurement, or they may include any appropriate categorization of potential causes of the problem. Direct cause subcategories associated with the respective general cause category are then received from the user interface module (step 110). Direct cause subcategories may include any number of causes associated with the general cause category.

Weighting factors associated with each of the general cause categories and direct cause subcategories are then received via the user interface module (step 112). Weighting factors may represent each of the general cause categories and direct cause subcategories respective portion of the problem. The weighting factors associated with the general cause categories are representative of the portion each general cause contributes to the problem, and the weighting factors associated with the direct cause subcategories are representative of the portion that each direct cause subcategory contributes to the respective general cause. After the cause-and-effect chart has been populated using the received general cause categories, direct cause subcategories, and weighting factors, the primary direct cause is automatically identified (step 114). The direct cause with proportionally the highest weighting factor, relative to the entire problem, is identified as the primary direct cause. If multiple primary direct causes are identified the user may be prompted to limit the scope of the system to a single primary direct cause. The Pareto principle, or any other appropriate quality control practice, may be utilized to identify and prioritize the most influential direct cause.

A root cause analysis report is then generated associated with the primary direct cause (step 116). The root cause analysis report includes a display of the cause-and-effect chart identifying the primary direct cause. The root cause analysis report also includes a user interface with a plurality of questions to determine the root cause of the problem, the first of a plurality of questions provided the user interface being based on the primary direct cause. After the user response to the first question is received the user is automatically prompted for a response to a second question via the user interface module. The user may be successively prompted for a response to a plurality of questions, each subsequent question being based on the response to the previous question, until the user has reached the desired level of specificity, and the root cause is identified. The root cause analysis report may also include a display that reports at least one recommendation for resolving the problem in the relevant environment.

The order in which steps and processes consistent with the disclosure are described herein is exemplary only. It will be apparent to those skilled in the art that order of performance may not be important and the steps and processes may be performed in an order different than that described. Therefore, one of skill in the art will recognize that the description of such actions is intended to be exemplary only.

### INDUSTRIAL APPLICABILITY

The disclosed system and method for identifying a root cause and corrective action plan associated with a problem in a production environment may assist users in quickly performing a problem analysis by providing a single interface, thus allowing users to apply several problem identification and improvement methodologies. Utilizing the system and method of the present disclosure may allow users to save time and resources that were previously wasted due to misidentified problem sources and prolonged and unfocused process improvement methods.

Although the disclosed embodiments are described as being associated with a production environment, they may also be applicable to any process or environment where it would be advantageous to accurately and thoroughly identify a problem and its root cause, and develop a corrective action plan that addresses the identified root cause. Furthermore, the systems and methods described herein may be provided as part of a software package that allows users to supply problem data and determine associated process and product root causes and corrective actions.

The presently disclosed system and method for identifying a root cause and a corrective action plan associated with a problem has several advantages. For example, unlike some conventional methods, it allows users to prioritize between multiple problems or causal elements. Utilizing the system and method of the present disclosure may allow users to evaluate what causal factors have a greater impact on the overall problem, thereby focusing problem evaluation and mitigation. This saves both time and resources, allowing users to dedicate their efforts where they will have the most impact.

Furthermore, the present system and method provides users with a report interface that automatically formats information into industry-recognized process improvement methodologies, providing users an easily interpreted analysis report. Combining conventional methods, such as, cause-and-effect charting and “5-why” analysis, into a single reporting format provides an efficient and time-saving output tool.

It will be apparent to those skilled in the art that various modifications and variations can be made in the disclosed root cause analysis system without departing from the scope of the disclosure. Additionally, other embodiments of the root cause analysis system will be apparent to those skilled in the art from consideration of the specification. It is intended that the specification and examples be considered as exemplary only, with a true scope of the disclosure being indicated by the following claims and their equivalents.

What is claimed is:

1. A computer-implemented method for identifying a root cause associated with a problem in a production environment, comprising:
receiving, from a user interface module, information indicative of a point-of-origin of the problem;
providing, via the user interface module, a cause-and-effect chart, the cause-and-effect chart having a plurality of user-definable general cause categories, each of the plurality of user-definable general cause categories having at least one user-definable direct cause subcategory;
receiving, from the user interface module, at least one general cause category and at least one direct cause subcategory associated with the cause-and-effect chart;
automatically identifying a primary direct cause of the problem based on the at least one general cause category and the at least one direct cause subcategory;
automatically generating a root cause analysis report associated with the identified primary direct cause, wherein generating the root cause analysis report includes:
providing a first analysis module that displays the cause-and-effect chart based on the at least one general cause category and the at least one direct cause subcategory; and
providing a second analysis module that prompts the user for a response to a first of a plurality of questions, wherein the response to the first of the plurality of questions automatically prompts the user for a response to a second of a plurality of questions.

2. The computer-implemented method of claim 1, wherein receiving the at least one general cause category and the at least one direct cause subcategory includes receiving a plurality of general cause categories and a plurality of direct cause subcategories.

3. The computer-implemented method of claim 2, wherein the cause-and-effect chart includes user-definable weighting factors associated with each of the user-definable general cause categories and direct cause subcategories.

4. The computer-implemented method of claim 3, wherein identifying the primary direct cause of the problem includes:
receiving, from the user interface module, user-defined weighting factors associated with each of the user-definable general cause categories and direct cause subcategories; and
identifying the primary direct cause of the problem based on the user-defined weighting factors.

5. The computer-implemented method of claim 4, wherein generating the root cause analysis report further includes identifying a root cause of the problem in response to user responses to the plurality of questions.

6. The computer-implemented method of claim 5, wherein generating the root cause analysis report further includes providing a third analysis module that reports at least one recommendation for resolving the problem in the production environment.

7. The computer-implemented method of claim 6, wherein the first analysis module, the second analysis module, and the third analysis module are provided in a single display format.

8. A computer-readable medium for use on a computer system, the computer readable medium having computer executable instructions for performing a method of identifying a root cause associated with a problem in a production environment, the method comprising:
receiving, from a user interface module, information indicative of a point-of-origin of the problem;
providing, via the user interface module, a cause-and-effect chart, the cause-and-effect chart having a plurality of user-definable general cause categories, each of the plurality of user-definable general cause categories having at least one user-definable direct cause subcategory;
receiving, from the user interface module, at least one general cause category and at least one direct cause subcategory associated with the cause-and-effect chart;
automatically identifying a primary direct cause of the problem based on the at least one general cause category and the at least one direct cause subcategory;
automatically generating a root cause analysis report associated with the identified primary direct cause, wherein generating the root cause analysis report includes:
providing a first analysis module that displays the cause-and-effect chart based on the at least one general cause category and the at least one direct cause subcategory; and
providing a second analysis module that prompts the user for a response to a first of a plurality of questions, wherein the response to the first of the plurality of questions automatically prompts the user for a response to a second of a plurality of questions.

9. The computer-readable medium of claim 8, wherein receiving the at least one general cause category and the at least one direct cause subcategory includes receiving a plurality of general cause categories and a plurality of direct cause subcategories.

10. A computer-readable medium of claim 9, wherein the cause-and-effect chart includes user-definable weighting factors associated with each of the user-definable general cause categories and direct cause subcategories.

11. A computer-readable medium of claim 10, wherein identifying the primary direct cause of the problem includes:
receiving, from the user interface module, user-defined weighting factors associated with each of the user-definable general cause categories and direct cause subcategories; and
identifying the primary direct cause of the problem based on the user-defined weighting factors.

12. A computer-readable medium of claim 11, wherein generating the root cause analysis report further includes identifying a root cause of the problem in response to user responses to the plurality of questions.

13. A computer-readable medium of claim 12, wherein generating the root cause analysis report further includes providing a third analysis module that reports at least one recommendation for resolving the problem in the production environment.

14. A computer-readable medium of claim 13, wherein the first analysis module, the second analysis module, and the third analysis module are provided in a single display format.

15. A system for identifying a root cause associated with a problem in a production environment, comprising
a console;
at least one input device coupled to a processor; and
the processor configured to:
receive, from a user interface module, information indicative of a point-of-origin of the problem;
provide, via the user interface module, a cause-and-effect chart, the cause-and-effect chart having a plurality of user-definable general cause categories, each of the plurality of user-definable general cause categories having at least one user-definable direct cause subcategory;
receive, from the user interface module, at least one general cause category and at least one direct cause subcategory associated with the cause-and-effect chart;
automatically identify a primary direct cause of the problem based on the at least one general cause category and the at least one direct cause subcategory;
automatically generate a root cause analysis report associated with the identified primary direct cause, wherein generating the root cause analysis report includes:
providing a first analysis module that displays the cause-and-effect chart based on the at least one general cause category and the at least one direct cause subcategory; and
providing a second analysis module that prompts the user for a response to a first of a plurality of questions, wherein the response to the first of the plurality of questions automatically prompts the user for a response to a second of a plurality of questions.

16. The system of claim 15, wherein receiving the at least one general cause category and the at least one direct cause subcategory includes receiving a plurality of general cause categories and a plurality of direct cause subcategories.

17. The system of claim 16, wherein the cause-and-effect chart includes user-definable weighting factors associated with each of the user-definable general cause categories and direct cause subcategories.

18. The system of claim 17, wherein identifying the primary direct cause of the problem includes:
receiving, from the user interface module, user-defined weighting factors associated with each of the user-definable general cause categories and direct cause subcategories; and
identifying the primary direct cause of the problem based on the user-defined weighting factors.

19. The system of claim 18, wherein generating the root cause analysis report further includes identifying a root cause of the problem in response to user responses to the plurality of questions.

20. The system of claim 19, wherein generating the root cause analysis report further includes providing a third analysis module that reports at least one recommendation for resolving the problem in the production environment,
wherein the first analysis module, the second analysis module, and the third analysis module are provided in a single display format.
